(19) United States
(12) Patent Application Publication
(10) Pub. No.: US 2007/0181173 A1
(43) Pub. Date: Aug. 9, 2007

(54) Solar electric power generator

(76) Inventors: Jeffrey B. Neubauer, Tucson, AZ (US); Grant M. Gibson, TUCSON, AZ (US)

Correspondence Address: QUARLES & BRADY LLP, ONE SOUTH CHURCH AVENUE, SUITE 1700, TUCSON, AZ, 85701-1621, US

(21) Appl. No.: 11/350,445

(22) Filed: Feb. 9, 2006

(51) Int. Cl. H02N 6/00

(52) U.S. Cl. 136/246

(57) ABSTRACT

A solar concentrator includes a first reflective surface formed parabolic along a first axis and a second reflective surface formed parabolic along a second axis which is perpendicular to the first axis. The focal length of the second reflective surface is shorter than the focal length of the first reflective surface for crossing focal lines of the first and the second reflective surfaces at a point. A method of concentrating solar light includes reflecting the light off a first reflective surface having a single parabolic axis to generate a first reflected line, and reflecting the first reflected line off a second reflective surface having a single parabolic axis. The parabolic axis of the first reflective surface is oriented perpendicular to the parabolic axis of the second reflective surface to focus the light to a point.

### BACKGROUND OF THE INVENTION

1. Field of the Invention

The present invention relates in general to solar collectors, and, more particularly, to a device that collects radiant energy from the sun, concentrates that energy, and converts it to electricity.

2. Description of the Related Art

In the past, photovoltaic (PV) cells have been used to convert solar radiant energy into electricity. However, despite substantial investment, they have not been widely adopted by the energy industry to generate electricity. There are a couple of reasons for this circumstance.

PV cells are very expensive to create per unit area. Their high cost has made the energy they produce too expensive to compete with conventional sources of energy such as natural gas and coal.

One way to reduce the area of PV cells needed to produce electricity is to concentrate sunlight onto the cells. If a collector can concentrate sunlight by a factor of 500, then 500 times less area of PV cells is needed to produce the same amount of electricity. Hence, the cost of the energy produced should be vastly reduced.

The idea of concentrating sunlight onto PV cells is not a new one, but the cost and problems associated with building a collector, known in the industry as a solar concentrator, more than offset the cost savings in the reduced number of PV cells. This has prevented PV cells adoption for large-scale electrical energy production.

Many solar concentrators fall into three primary design categories. The first is known in the industry as a solar trough. This design utilizes a single mirror that is parabolic along only one axis that looks something like a trough. This mirror collects sunlight and then focuses this sunlight into a line. At the focus can be a pipe that contains a working substance to be heated, or PV cells. This design has the advantage of a mirror that is easy to manufacture in small sizes since it is curved in only one direction and it is relatively easy to apply a reflective coating. Another advantage is the light in the focal plane can form a rectangular shape, important for focusing light onto rectangular PV cells. The primary drawback to this design is that since sunlight is concentrated only along one axis, a very large mirror is required to achieve high concentrations. Constructing and controlling such large mirrors turns out to be a costly endeavor, in fact, too costly to offset the savings produced by needing fewer PV cells. Ideally a solar concentrator should focus light to as small of an area as possible.

The second design category is the parabolic dish. This design uses a single parabolic mirror that is similar in shape to a large satellite dish. The mirror collects sunlight and focuses it to a focal point. At this focal point can be PV cells or a heat engine such as a sterling engine. The advantage of this design is that it can achieve high concentrations with a small amount of mirror surface. The primary drawback to this design is that the mirror has a compound curve (i.e. is curved along more than one axis and looks like a bowl). Because it is difficult to manufacture an accurate compound curve on almost any substance, the cost of making a parabolic mirror of this type (known as a paraboloid), like the mirrors used in optical telescopes, tends to go up exponentially with size. In the context of plastics manufacturing, thermoforming cannot be easily used to produce such a mirror, but injection molding must be used instead. This ultimately limits the practical size of the mirrors that can be produced cost-effectively. In addition, since the curve is a compound one and a reflective film would wrinkle if applied to such a shape, a reflective coating must be applied in a vacuum chamber. This chamber can be very costly to create in a large size, also limiting the practical size of the mirror. Another drawback is light is typically focused to a circular region, which is not ideal for focusing light onto rectangular PV cells. Again, the cost of making optics of this type for a concentrator large enough to produce a reasonable amount of power more than offsets the cost savings produced by needing fewer PV cells.

The third design category is the “power tower.” This design uses many heliostats (small mirrors that track the sun) and points them all to a common focal point. At this focal point can be PV cells or a sterling engine. The advantage of this design is smaller mirrors are easy to manufacture and can be potentially done in a way that is more cost effective. A disadvantage of this design is that each mirror needs a system to track the sun, which increases costs. Another disadvantage is that these heliostats need to be compound parabolic mirrors in order to achieve high concentration ratios, which also dramatically increase costs and limits the size each heliostat can be practically manufactured.

In light of these three designs, a need exists for a solar concentrator which is less costly to manufacture yet still operates effectively.

### SUMMARY OF THE INVENTION

The solar electric power generator of the present invention combines the best aspects of the parabolic trough and the parabolic dish while using inexpensive plastics that can be thermoformed. This is achieved by the present invention by concentrating solar radiant energy to a small area, like a parabolic dish, but using only mirrors that are parabolic along a single axis, just like a parabolic trough. The importance of this fact is that trough-like mirrors are far easier and cost effective to produce than concave bowl-like optics.

The device consists of two reflective mirrors, a primary and secondary mirror, that can be any two-dimensional shape, but preferably rectangular, that are aligned along an optical axis. Each of these mirrors has a parabolic curve along one axis and is flat along the other axis. Hence, each mirror looks similar to a parabolic trough and can take parallel light rays and focus them to a line. However, the focal length of the secondary mirror must be shorter than that of the primary mirror since each axis of incoming light is focused independently of the other, yet they must still focus at the same point.

The present invention works as follows. First, the radiant energy of the sun is reflected off a larger mirror, known as the primary mirror, toward the secondary mirror. As the radiant energy moves toward the secondary mirror, this energy is being concentrated along a single axis. The energy is then reflected from the secondary, which acts to concentrate the energy along an axis that is perpendicular to the axis by which the primary concentrates the energy. This allows the energy to come to a focus after reflecting from the secondary mirror.

There are two primary embodiments for the present invention. They consist of on-axis and off-axis embodiments. The on-axis embodiment uses two mirrors that have line foci located directly above their centers. This embodiment has the secondary mirror located directly above the primary mirror, shadowing it. In addition, it is likely a strip would have to be cut in the center of the primary mirror so the light would be focused behind it. This is because the supports for the heat sink the solar cells are mounted to will cause further shadowing. This situation is not ideal. In the preferred off-axis embodiment, the primary mirror is a section of an off-axis parabola, so the line focus does not occur right above the center of the mirror like a parabolic trough, but off to one side instead. This is so the secondary mirror and the solar cells do not shadow the primary mirror. The advantages of this circumstance is that whole surface of the primary can be used to collect light, and the fact that there is no dark spot created by the secondary mirror in the image planes that are just out of focus. This fact allows for even illumination of the solar cells in image planes that do not intersect the focal point of the concentrator allowing for precise control of the image size by moving the image plane along the optical axis. The image plane itself is tipped such that the image is near rectangular, making it compatible with solar cell design, so that almost all of the light collected can be harvested by the solar cells. The aspect ratio of this rectangular area can be adjusted by changing the distance of the secondary mirror from primary, allowing the flexibility to use square or rectangular solar cells.

The mirrors of the device can be made of any plastic that can be thermoformed, such as Acrylic or Polycarbonate, coated with a reflective Mylar film that can be protected from UV radiation via a poly-vinyl substrate. Since the curve on each of the mirrors used in the present invention is not a compound curve, a flat sheet of Acrylic can be easily thermoformed to the desired curve using a thermoforming technique that is inexpensive to implement. In addition, because of the same advantage of the present invention, it is possible to apply a reflective film without wrinkling it to the thermoformed plastic sheet. This is an improvement over using a compound curve mirror, like the mirror used in a parabolic dish, since this type of mirror has to be coated in a vacuum chamber, which is prohibitively expensive for large mirrors.

Each mirror rests on a set of supports that help each mirror keep its optical shape. This set of supports is known as a mirror cell. The mirror cell plays an important role in the present invention since plastics in general are not dimensionally stable. The mirror cell consists of braces made of circular tubing that cross the mirror to be supported parallel to the short axis of the mirror at regular intervals with a brace located on each end of the mirror. These supports must be adjoined to the mirror in a manner that does not distort its figure. The ends of these supports have holes drilled in them that allow threaded rod to be placed through them. This rod is then passed through holes in braces that run parallel to the long axis of mirror. The rod is secured with nuts to the braces. The nuts can be adjusted so the mirror shape can be fine-tuned. Additional support can optionally be provided by braces made from thick, but flat acrylic sheet cut to match the mirror's curved shape that are adjoined to the mirror on each long edge and can be spaced at regular intervals parallel to the long axis of the mirror.

The mirror cells of the device are then supported by a structure that maintains their optical alignment. This structure in turn is placed on any type of telescope mount that can track the sun's movement across the sky.

PV cells are located in an image plane that either coincides with the focal plane of the mirrors, or a plane that is parallel to the focal plane that intersects the optical axis in a manner that allows them to be illuminated by the concentrated solar radiant energy. These PV cells change the solar radiant energy into electrical energy and are mounted on a heat sink that keeps them cool. In addition, instead of concentrating solar radiant energy onto PV cells, the present invention can be used to run a heat engine, such as a sterling engine. Heat engines in their present state of technology are generally not preferable to PV cells, however, due to maintenance concerns such as the need to be running for long periods of time with no breakdowns.

The present invention can achieve the high concentrations needed to reduce the number of expensive PV cells to a minimum in a way that minimizes overall cost. This is because the design of the present invention allows for the use of inexpensive materials and can be manufactured using methods that are straightforward and cost effective.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a ray diagram of the present invention;

FIG. 2a illustrates a side view of an off-axis embodiment of the present invention;

FIG. 2b illustrates a top view of an off-axis embodiment of the present invention;

FIG. 3 illustrates a focal area of the present invention; and

FIG. 4 illustrates a side view of an on-axis offset embodiment of the present invention;

### DETAILED DESCRIPTION OF THE DRAWINGS

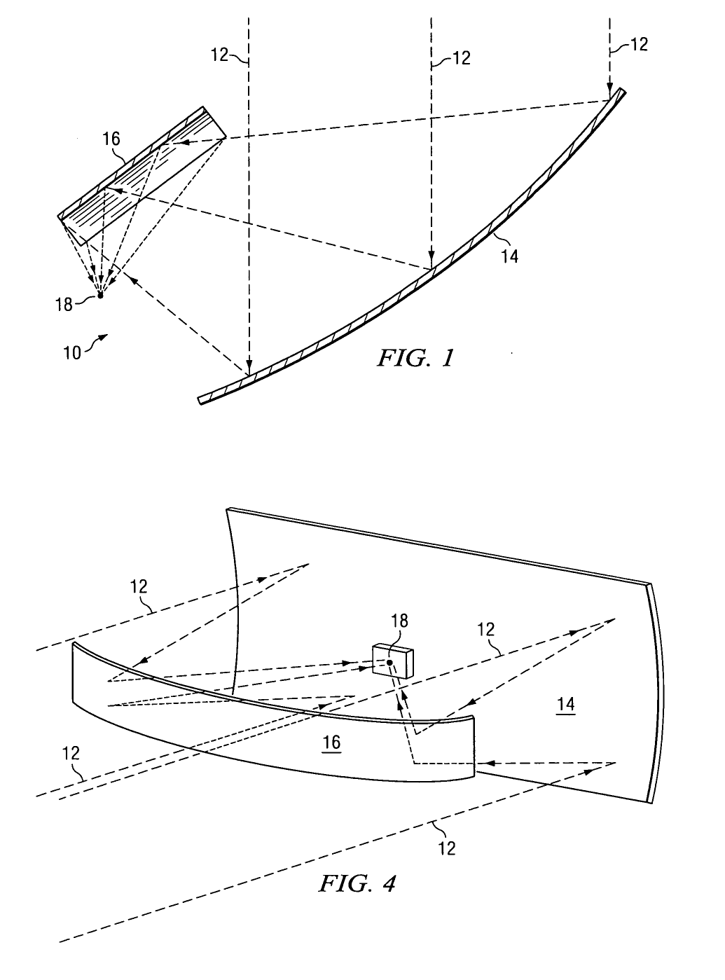

Turning to FIG. 1, a ray diagram illustrating an optical path for concentrated solar light according to the present invention is depicted. Solar concentrator 10 includes a reflective surface 14 which serves as a primary mirror. Light rays 12 are shown striking surface 14 and reflecting towards reflective surface 16 which serves as a secondary mirror. Surface 14 is formed to be parabolic along a first axis (coming out of the page), and flat along a second axis. Surface 16 is also formed to be parabolic along a first axis, and flat along a second axis. Each surface 14,16 is similar in shape to a parabolic trough versus a concave bowl.

The physical properties of surface 14 are such that reflected light 12 consists of a line of light along the parabolic axis of the surface 14. Reflected light 12 is directed to surface 16, where it is directed to focal point 18. The parabolic axis of surface 14 is intended to be oriented perpendicular to the parabolic axis of surface 16. Again, the physical properties of surface 16 are also such that reflected light 12 consists of a line of light along the parabolic axis of the surface 16. Surfaces 14 and 16 can be oriented such that the reflected line of light 12 is first reflected by surface 14 and concentrated along a single, first parabolic axis of surface 14. The reflected light 12 is then reflected from surface 16, which acts to concentrate the reflected light 12 along a second parabolic axis which is perpendicular to the first parabolic axis. The reflected light 12 then comes to a focus on focal point 18 after being reflected from surface 16.

Surfaces 14 and 16 can be thought of and include such optical devices as primary and secondary mirrors. A focal length of secondary mirror 16 must be shorter than that of the primary mirror 14 since each axis of incoming light is focused independently of the other, yet primary mirrors 14 and 16 must still focus at the same focal point 18.

Focal point 18 can include, as previously described, a plurality of PV cells 18 which lie in an image plane coinciding with the focal plane of surface 14 and surface 16, or in any manner which allows the PV cells to be illuminated by the concentrated radiant solar energy. Focal point 18 can include a single, focused point. Additionally, mirrors 14 and 16 can be configured to focus light substantially to a focal point 18, in effect not focusing light to the exact same point in space. An example of focusing light substantially to a focal point 18 could include focusing light to a small rectangular or square area rather than a very small circular point. By varying how focused each mirror 14 and 16 is focused on their respective axes 15 and 17, the concentration of reflected sunlight on focal point 18 (and thereby, PV cells) can be independently adjusted.

In addition to concentrating solar radiant energy onto PV cells, the present invention can be used to run a heat engine, such as a sterling engine. Focused radiant energy coinciding with focal point 18 can be utilized to warm an external heat source component (not shown) of a sterling engine. As previously described, heat engines in their present state of technology are generally not preferable to PV cells, however, due to maintenance concerns such as the need to be running for long periods of time with no breakdowns.

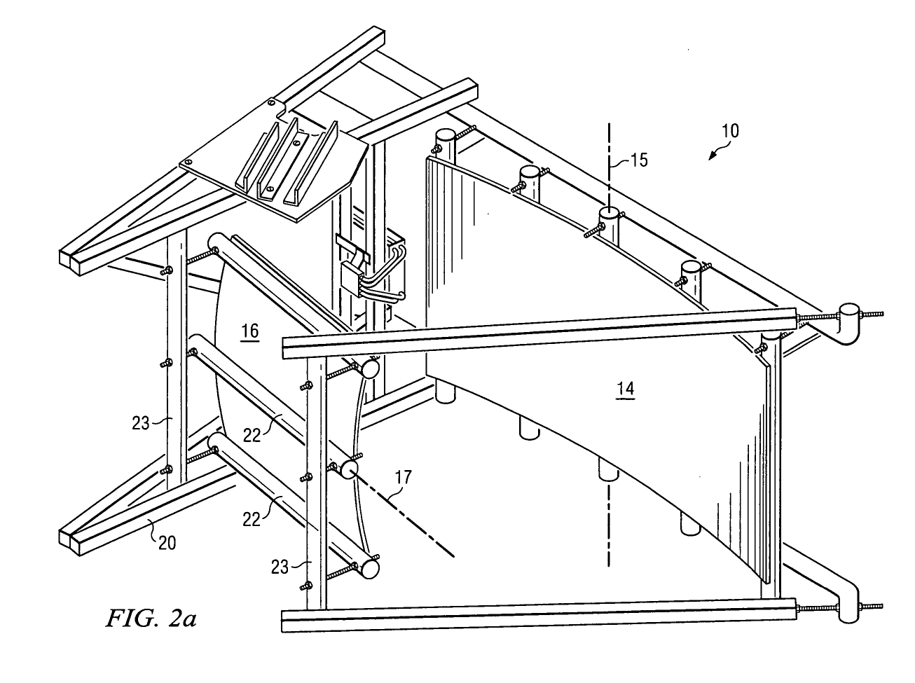

FIG. 2a illustrates a side view of an example embodiment of a solar concentrator. Primary mirror 14 is formed parabolic along a single axis 15. Secondary mirror 16 is also formed parabolic along a single axis 17. A support structure 20 includes metal bracing to hold mirrors 14,16 in place. Again, as previously described, mirrors 14,16 can be made of any plastic material that can be thermoformed, such as acrylic or polycarbonate. Mirrors 14,16 can be coated with a reflective film such as Mylar® or a similar material that can be protected from UV radiation via a polyvinyl substrate. A flat sheet of acrylic can be thermoformed to the desired curve using techniques which are well known in the art. Additionally, the reflective film can also be applied to the acrylic using well-known methods.

Mirrors 14,16 are shown coupled to supports 22 or mirror cells 22 to help mirrors 14,16 retain their shape. Mirror cells 22 include braces made of circular tubing which cross mirrors 14,16 to be supported parallel to the short axis of the mirrors 14,16 at regular intervals with a brace 23 located at each end of the mirror 14,16. Mirror cells 22 must be adjoined to the mirrors 14,16 in a manner that does not distort the shape of mirrors 14,16.

Turning to FIG. 2b, a top view of the present embodiment of a solar collector is depicted. Primary mirror 14 is again shown formed parabolic along axis 15. As depicted, the ends of mirror cells 22 have holes drilled in cells 22 which allow a threaded rod 24 to be placed thorough cells 22. Rods 24 are passed through holes in braces 25 which run parallel to the long axis of mirror 14,16. Rods 24 are secured with nuts 26 to the braces 25 and cells 22, as shown. The nuts 26 can be adjusted so the mirror 14,16 shape can be fine-tuned. In a separate embodiment, additional support can be optionally provided by braces constructed from thick, flat acrylic sheets which are cut to match the curved shape of mirrors 14,16. The braces can be adjoined to the mirrors 14,16 on each long edge and can be spaced at regular intervals parallel to the long axis of the mirrors 14,16.

As previously described, mirrors 14,16 can be supported by any support structure 20 which maintains the optical alignment of mirrors 14,16. Support structure 20 can be mounted on any telescope mount known in the art which tracks the sun's movement across the sky. A bank of a plurality of PV cells 28 is located at focal point 18. Heat sink 29 is mounted to PV cells 28 for heat dissipation.

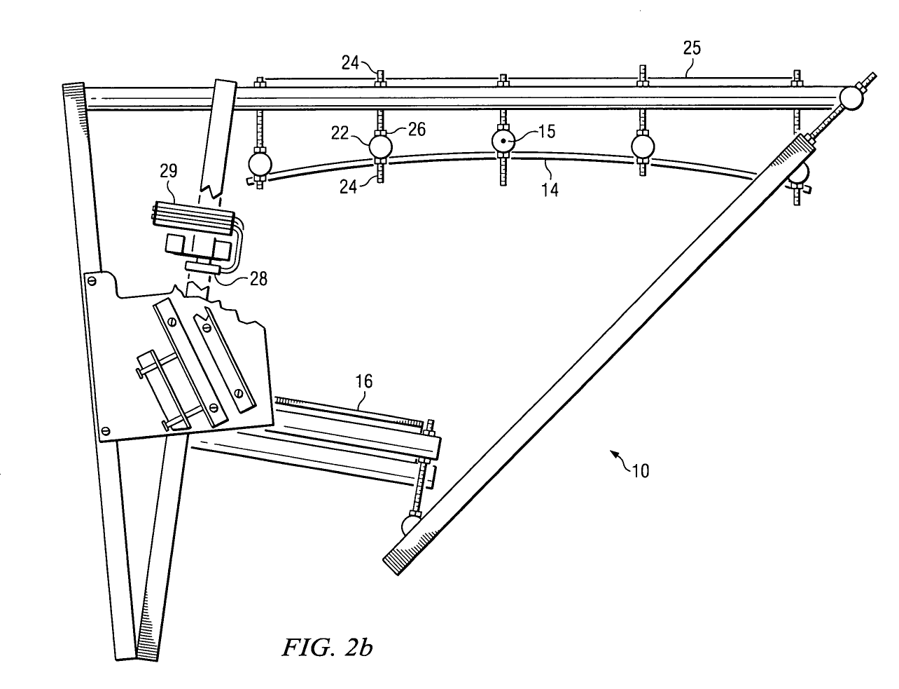

FIG. 3 depicts a bank of a plurality of PV cells 28 located at focal point 18 according to the present invention. Support structure 20 holds PV cells 28 in place at focal point 18. Again, a heat sink 29 is disposed behind PV cells 28 for heat dissipation. Secondary mirror 16 is shown formed parabolic along axis 17. An additional close-up view of mirror cells 22 mounted to support structure 20 is shown using braces 23, rods 24, and nuts 26.

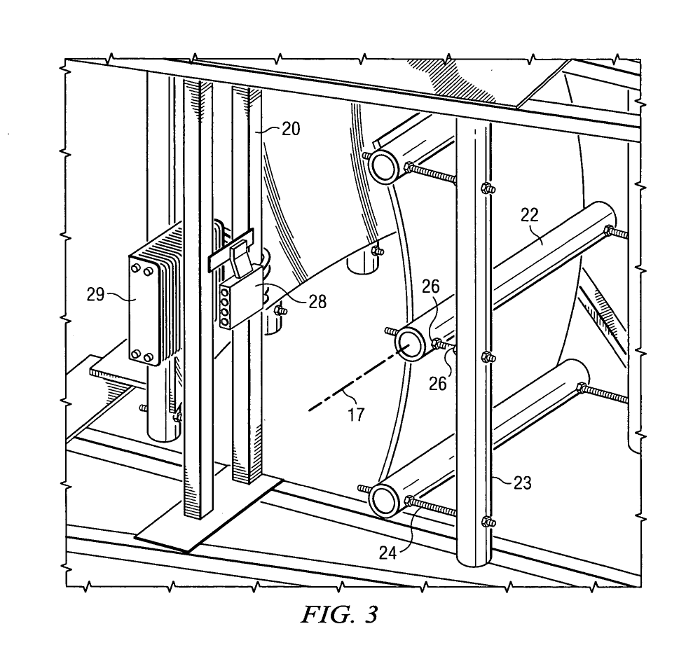

Turning to FIG. 4a, a front view of an on-axis offset embodiment of the present invention is depicted. The on-axis embodiment, as previously described, uses two mirrors 14,16 which have line foci located directly above the centers of mirrors 14,16. The secondary mirror 16 is located directly above the primary mirror 14, shadowing the primary mirror 14. In the depicted orientation, a strip would likely need to be cut in primary mirror 14 to allow light 12 to be focused behind primary mirror 14 due to further shadowing from support structure 20. FIG. 4b shows a top-view of a ray diagram depicting the on-axis embodiment. Light 12 is reflected off primary mirror 14 to secondary mirror 16, and then reflected towards focal point 18.

While one or more embodiments of the present invention have been illustrated in detail, the skilled artisan will appreciate that modifications and adaptations to those embodiments may be made without departing from the scope of the present invention as set forth in the following claims.

What is claimed is:

1. A solar concentrator, comprising:
a first reflective surface formed parabolic along a first axis; and
a second reflective surface formed parabolic along a second axis which is perpendicular to the first axis, wherein a focal length of the second reflective surface is shorter than a focal length of the first reflective surface for crossing focal lines of the first and the second reflective surfaces at a focal point.

2. The apparatus of claim 1, wherein the first reflective surface further comprises a section of an off-axis parabola having an off-center line focus.

3. The apparatus of claim 1, wherein the first and second reflective surfaces further comprise a primary and a secondary mirror.

4. The apparatus of claim 1, wherein the first reflective surface is two-dimensional in shape.

5. The apparatus of claim 4, wherein the first reflective surface is rectangular in shape.

6. The apparatus of claim 1, wherein the first and second reflective surfaces are further comprised of thermoformed plastic coated with a reflective film.

7. The apparatus of claim 1, wherein the first reflective surface is mounted to a brace which is supported parallel to a short axis of the first reflective surface.

8. The apparatus of claim 1, further including a plurality of photovoltaic cells configured in an image plane to coincide with a focal plane of the first and second reflective surfaces for energy conversion.

9. The apparatus of claim 1, further including a heat source component coinciding with a focal plane of the first and second reflective surfaces for energy conversion.

10. A solar concentrator, comprising:
a primary mirror having a single parabolic axis;
a secondary mirror having a single parabolic axis, wherein the parabolic axis of the secondary mirror is oriented to be perpendicular to the parabolic axis of the primary mirror.

11. The apparatus of claim 10, wherein a focal length of the secondary mirror is shorter than a focal length of the primary mirror allowing a focal line of the primary mirror to cross a focal line of the secondary mirror at a focal point.

12. The apparatus of claim 10, wherein the primary mirror further comprises a section of an off-axis parabola having an off-center line focus.

13. The apparatus of claim 10, wherein the primary mirror further comprises a rectangular shape.

14. The apparatus of claim 10, wherein the primary mirror is further comprised of thermoformed plastic coated with a reflective film.

15. The apparatus of claim 10, further including a plurality of photovoltaic cells configured in an image plane to coincide with a focal plane of the primary and secondary mirrors.

16. The apparatus of claim 10, further including a heat source component configured to coincide with a focal plane of the primary and secondary mirrors for energy conversion.

17. A method of concentrating solar light, comprising:
reflecting the light off a first reflective surface having a single parabolic axis to generate a first reflected line;
reflecting the first reflected line off a second reflective surface having a single parabolic axis, wherein the parabolic axis of the first reflective surface is oriented perpendicular to the parabolic axis of the second reflective surface to focus the light to a focal point.

18. The method of claim 17, wherein a focal length of the second reflective surface is shorter than a focal length of the first reflective surface.

19. The method of claim 17, wherein the reflective surfaces further comprise a primary and secondary mirror.

20. The method of claim 17, wherein the first reflective surface further comprises a section of an off-axis parabola having an off-center line focus.

21. A method of manufacturing a solar concentrator, comprising:
providing a primary mirror having a single parabolic axis;
providing a secondary mirror having a single parabolic axis, wherein the parabolic axis of the secondary mirror is oriented to be perpendicular to the parabolic axis of the primary mirror.

22. The method of claim 21, wherein a focal length of the secondary mirror is shorter than a focal length of the primary mirror allowing a focal line of the primary mirror to cross a focal line of the secondary mirror at a focal point.

23. The method of claim 21, wherein the primary mirror further comprises a section of an off-axis parabola having an off-center line focus.

24. The method of claim 21, further including providing a plurality of photovoltaic cells configured in an image plane to coincide with a focal plane of the primary and the secondary mirror.

25. The method of claim 21, wherein the primary mirror is further comprised of thermoformed plastic coated with a reflective film.
